(19) United States
(12) Patent Application Publication
(10) Pub. No.: US 2009/0052532 A1
(43) Pub. Date: Feb. 26, 2009

(54) AUTOMATICALLY IDENTIFYING EDGES OF MOVING OBJECTS

(76) Inventor: Simon Robinson, Collingham (GB)

Correspondence Address: PERKINS COIE LLP;PATENT-SEA, P.O. BOX 1247, SEATTLE, WA, 98111-1247, US

(21) Appl. No.: 11/844,725

(22) Filed: Aug. 24, 2007

(51) Int. Cl. H04N 7/26

(52) U.S. Cl. 375/240.13; 375/E07.188

(57) ABSTRACT

The edge identification system receives a pair of images from which an in-between image is to be created. The edge identification system calculates two vector fields: one to warp the second image onto the first, and the other to warp the first image onto the second. The two vector fields are typically symmetric; however, the fields are not symmetric along the edge of an object (e.g., the foreground) that is moving differently than the layer behind it (e.g., the background). This type of movement creates occlusions in which an object that was visible in one image will not be visible in the other image and vice versa. The edge identification system uses these areas to automatically identify the edges of moving objects. Thus, the edge identification system can identify the edges of objects without requiring the user to provide a matte or other manual assistance.

### BACKGROUND

Optical flow is the field that deals with tracking every pixel in a moving image. In the simplest terms, optical flow tracks every pixel in one frame to the next frame. The output is a series of vectors for every pixel in the shot. At the macro level, optical flow describes the movement of objects in a scene or movement from camera motion. In the world of visual effects, optical flow started as a tool for retiming shots without producing strobing, and today it is used for tracking, 3D reconstruction, motion blur, auto rotation, and dirt removal. Retiming involves taking a sequence that was filmed at one speed and slowing down or speeding up the sequence to create a desired effect. For example, the movie The Matrix contains a scene where the primary actor is shown bending backwards as a bullet flies over him, a shot made possible through retiming and optical flow.

When retiming a sequence to a slower speed, it is often necessary to create additional frames to keep a satisfactory visual appearance. For example, the human eye typically requires 30 frames per second (fps) to perceive motion correctly. If a sequence is filmed at 30 fps and then slowed down 2×, then the sequence will play at 15 fps, leaving gaps in the motion. This is often fixed by the creation of “in-betweens,” or intermediate frames that fill in the gaps to get the playback rate back up to an acceptable level. The creation of in-betweens requires good estimation of where objects in the prior and subsequent frames should be placed in the in-between frame. Mathematical methods are used to estimate the motion of objects in the frame and then place the objects in the in-between frames.

Optical flow typically relies on an assumption called “brightness constancy” that assumes that image values, such as brightness and color, remain constant over time, though their 2D position in the image may change. Algorithms for estimating optical flow exploit this assumption in various ways to compute a velocity field that describes the horizontal and vertical motion of every pixel in the image. In real scenes, the assumption is violated at motion boundaries and by changing lighting, nonrigid motions, shadows, transparency, reflections, etc. Optical flow typically starts with attempting to track everything in one frame with the next frame. This process is often based on motion segmentation (breaking the shot down into regions), which produces motion fields or velocity maps. Optical flow also typically divides these regions into layers. For example, a car driving past a house with a tree out in front may result in the car on one layer, the tree on another, and the house on a third layer. The better the software is at picking the edges between these things, the better the optical flow will appear.

Unfortunately, available tracking algorithms have difficulty detecting the edges between objects, particularly when the tracked object goes behind another object or off the edge of the image. The problem areas are typically seen as dragging of the image background along the leading and trailing edges of a fast-moving foreground object that is moving against a textured background. Regions where the background is being revealed or obscured are typically referred to as occlusions. A technique used in the past is to ask the user to draw a simple matte around the moving area. For example, if the foreground moves and the background does not, receiving a matte from the user that surrounds the moving area allows typical optical flow techniques to correctly apply effects without visible artifacts. If the user simply draws a matte around the moving area, the retimer is able to compute the foreground and background motions separately and combine them to get the best result. However, asking the user to manually identify objects and draw mattes is a difficult and time-consuming process that reduces the time available for the user to do other things.

### BRIEF DESCRIPTION OF THE DRAWINGS

FIG. 1 illustrates the components of the edge identification system in one embodiment.

FIG. 2 illustrates an example layout of a vector field between two images.

FIG. 3 illustrates the creation of an intermediate image between two existing images in one embodiment.

FIG. 4 is a flow diagram that illustrates the steps performed by the create intermediate image component in one embodiment.

### DETAILED DESCRIPTION

### Overview

An edge identification system for automatically identifying the edges of moving regions in an image sequence is provided. The edge identification system receives a pair of images, typically consecutive images from a video sequence, from which an in-between image is to be created. The edge identification system uses optical flow techniques to calculate a vector field describing the offsets from the current pixel location in one image to the corresponding matching pixel in the other image of the image pair. The vector field can be considered a description of a per-pixel transformation that can warp the second image onto the first. For this reason, the two images are often referred to as a reference image and a warp image. In one embodiment, the edge identification system calculates two vector fields: one to warp the second image onto the first, and the other to warp the first image onto the second. The two vector fields are typically symmetric (i.e., the field to warp the first image onto the second should be the inverse of the field to warp the second image onto the first). Although this is generally true, the fields are not symmetric along the edge of an object (e.g., the foreground) that is moving differently than the layer behind it (e.g., the background). This type of movement creates occlusions in which an object that was visible in one image will not be visible in the other image and vice versa. Therefore, there will be no good match for the object in one of the images. The edge identification system uses these areas to automatically identify the edges of moving objects. Thus, the edge identification system can identify the edges of objects without requiring the user to provide a matte or other manual assistance.

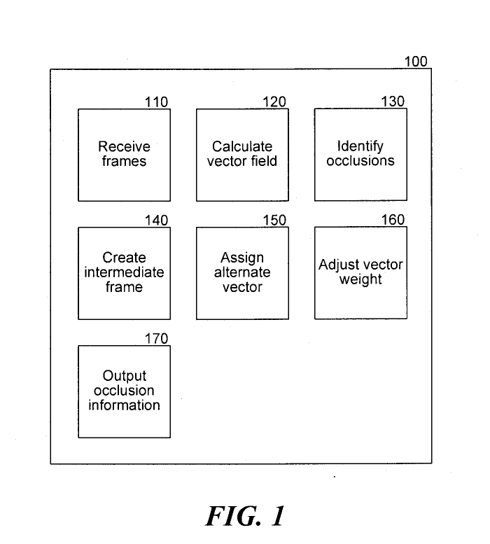

FIG. 1 illustrates the components of the edge identification system in one embodiment. The edge identification system 100 contains a receive frames component 110, a calculate vector field component 120, an identify occlusions component 130, a create intermediate frame component 140, an assign alternate vector component 150, an adjust vector weight component 160, and an output occlusion information component 170. A summary of these components is provided here with further details described in following sections.

The receive frames component 110 receives two sequential frames for which edges are to be identified. The calculate vector field component 120 computes a vector field between the two frames. In some embodiments, the calculate vector field component 120 computes two vector fields, one to warp each frame onto the other. The identify occlusions component 130 identifies occlusions in the frames based on asymmetries in the computed vector fields. The create intermediate frame component 140 creates one or more frames between the two received frames. For example, a retimer may request that the edge identification system create intermediate frames when slowing down a sequence. The assign alternate vector component 150 assigns vectors to regions of the new intermediate frame for which no vector already exists due to occlusions. The adjust vector weight component 160 changes the weight of the assigned alternate vectors to properly blend the occluded region with adjacent regions. The output occlusion information component 170 provides information determined by the edge identification system 100 to other components, such as a retimer or motion blur component.

The edge identification system minimizes motion defects by (a) detecting where the occlusion regions occur and (b) building in-between images that consider occlusion effects. Each of these processes is described in further detail below.

### Identifying Occlusions

The edge identification system minimizes motion defects by first detecting where occlusion regions occur.

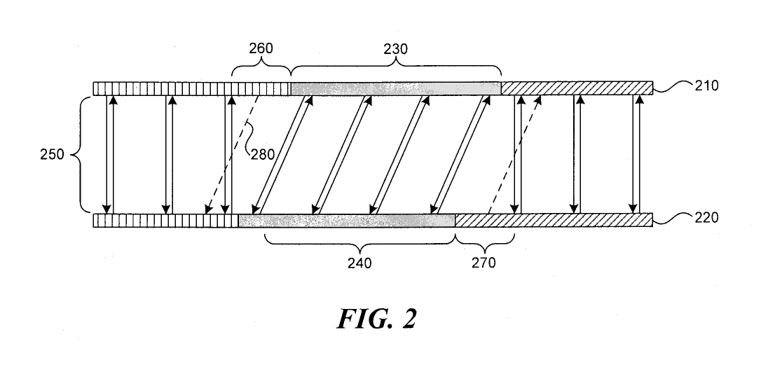

FIG. 2 illustrates an example layout of a vector field between two images. Although the images will typically be two-dimensional, they are depicted as one-dimensional for ease of illustration. The two horizontal lines 210 and 220 represent the two images (imagine them as images viewed edge-on). The identified regions 230 and 240 represent the position of a moving object that is displaced from one frame to the next. For simplicity of description, we assume that the rest of the image is stationary, although the techniques described herein extend to moving layers. The arrows 250 represent the vectors in the vector fields between the images 210 and 220. The arrows starting on image 210 and ending on image 220 show which pixels in image 210 have been determined to match pixels in image 220. Each pixel in image 210 has such a vector. Similarly, the arrows starting on image 220 and ending on image 210 show, for every pixel in image 220, an appropriate match in image 210.

For the most part, the matches are symmetrical. However, in the identified regions 260 and 270 an occlusion occurs, and there is no good match for a pixel in one image in the other image. These are areas where the corresponding background region in one image is simply not available in the opposing image. Frequently in this case a vector 280 is assigned that points from the image 210 to the best possible match in the other image 220. The conventional way of making vectors point to the best possible match tends to result in vectors in occluded regions pointing to similar neighboring regions in the background elsewhere, even if the match is not perfect, simply because it is a better choice than pointing into the foreground, where the quality of a match may be extremely low.

This motion defect is a consequence of trying to represent two distinct motions in one region using the same vector field. It manifests itself as a visible defect in most current retimers, where the motion of the foreground object appears to warp the background around the leading and trailing edges of the foreground object.

### Building Intermediate Images

The edge identification system also minimizes motion defects by building in-between images that consider identified occlusion effects. To understand this, we first describe how the edge identification system builds an intermediate image in general, followed by how the system considers occlusion regions.

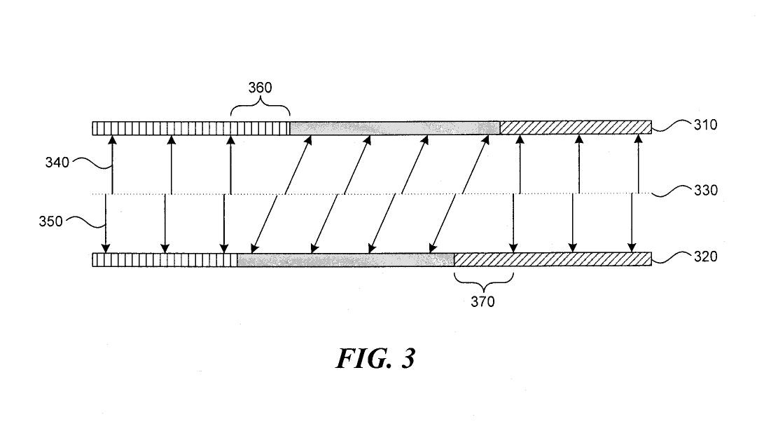

FIG. 3 illustrates the creation of an intermediate image between two existing images in one embodiment. The figure contains two images 310 and 320, and an intermediate image 330 that the edge identification system will create between the two existing images. For clarity, the figure illustrates how to build an intermediate image 330 halfway between the two existing images 310 and 320. However, the technique described herein applies no matter at what time interval the intermediate image 330 is constructed (e.g., ¼, ¾, etc.). A dotted line in the figure represents the intermediate image 330. Every pixel of the new intermediate image 330 is assigned a vector 340 that is taken from the vectors that intersect the plane of the intermediate image 330.

Each pixel position in the intermediate image 330 has two vectors 340 and 35—one pointing to a location in the first image 310 and one pointing to a location in the second image 320. To build the intermediate image 330, every location is filled with a blend of the pixel at the end of each vector. In this case, the blend is 50/50. If the intermediate image 330 were being built closer to image 320, then the weight of the image 320 would be increased.

Some regions 360 and 370 of the intermediate image 330 do not have two vectors filled in. This generally occurs in regions where occlusions occur. Detecting these regions is the first phase performed by the edge identification system. At these regions, the edge identification system assigns alternative vectors to replace the absent ones. The edge identification system also adjusts the weight of the vector from 50/50 to a new value that reduces the visibility of the background-dragging effect.

In some embodiments, the edge identification system assigns a vector to the new intermediate frame by calculating an offset from a current location based on the vector field from the first to the second image. By construction, the vector from the first to the second image at the current location is likely to be associated with the moving foreground object. Thus, using the offset in the occlusion area likely places the offset location outside of the moving foreground object. If the vector for the intermediate frame at the offset location exists, then the edge identification system assigns the same vector to the current location. Otherwise, if the vector for the intermediate frame at the offset location does not exist, then the edge identification system assigns the vector for the vector from the first to the second image at the current location.

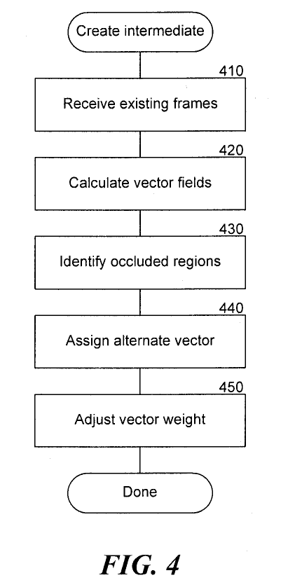

FIG. 4 is a flow diagram that illustrates the steps performed by the create intermediate image component in one embodiment. In block 410, the component receives two existing frames between which a new intermediate frame is to be created. In block 420, the component calculates a vector field from each frame to the other frame. In block 430, the component identifies occluded regions. For example, the component may identify asymmetries in the two created vector fields and correlate these asymmetries with occluded regions.

In block 440, the component assigns an alternate (e.g., warp) vector to occluded regions for which a vector does not exist in either of the received frame fields. For example, for a given location, the component may offset the vector at that location of one of the frames to identify a new location. If a warp vector exists for the new location, then the warp vector is assigned to the given location. If the warp vector does not exist for the new location, then the warp vector for the existing frame at the given location is assigned as the warp vector for the given location. By following the existing frame vector (which is likely associated with the moving foreground object in the occlusion region) to find the warp vector, and offsetting the existing frame vector's value, the edge identification system is likely to find a region outside of the moving foreground object and assign its value to the intermediate frame.

In block 450, the component adjusts the assigned vector's weight to properly blend the regions of the new intermediate frame. If the intermediate frame is exactly halfway between the two existing frames, then the existing frame's vector contribution should be 50/50. After block 450, these steps conclude.

### Adjusting Vector Weights

In some embodiments, the edge identification system determines the weight of a particular alternate vector according to the following formula:

newdelta=1+delta+(1−|np01(M).ni01(M)|)*delta*w

In this formula, np01(M) is a normalized version of the assigned alternate vector pointing from the new intermediate frame in the direction from the first existing image (i0) to the second existing image (i1) at position M. The dot product of this vector with the normalized vector from the existing first frame to the existing second frame at position M is determined. The value of delta is 0.5 when the new intermediate frame is halfway between the two existing frames. The value w is a user-tunable weighting (e.g., 1,000). According to this formula, the weighting of the occluded area is at least (1+delta), but the occluded area has more weight associated with it if p01(M) and i10(M) are not parallel. This prevents the edge identification system from adding too much weight where there is not much local divergence of vector fields (i.e., the dot product of the vectors is close to 1). Where there is divergence, the occlusion is presumed strong, and the additional weight forces the reconstruction to primarily use the background data in the occluded area. The edge identification system performs similar vector substitution and weighting adjustments for the other vector field (where delta is replaced by idelta, pox by p10, and i01 by i10).

In some embodiments, the edge identification system filters the resulting per-pixel delta and idelta values to avoid any sharp visual discontinuities between occlusion and non-occlusion areas. This is done by applying a Gaussian filter of tap 6 to the arrays of deltas and ideltas before the final picture build.

In the final build, at each pixel site, a pixel p1 is looked up in i1 by bilinear interpolation by following the vector p01, and a pixel p0 is looked up in i0 by bilinear interpolation from the end of the vector p10. The final pixel value is then calculated as:

result=1/(idelta+delta)*(idelta*p0+delta*p1)

An area of occlusion in the p01 vector field will insert a background vector into p01 and will have heavily weighted delta to dominate the rest of the mix.

### Conclusion

From the foregoing, it will be appreciated that specific embodiments of the edge identification system have been described herein for purposes of illustration, but that various modifications may be made without deviating from the spirit and scope of the invention. Accordingly, the invention is not limited except as by the appended claims.

I/We claim:

1. A method in a computer system for producing an intermediate frame based on two existing frames, the method comprising:
receiving a first frame and a second frame, wherein the first and second frames are part of a sequence;
calculating a forward vector field to warp the first frame onto the second frame;
calculating a reverse vector field to warp the second frame onto the first;
automatically identifying at least one occluded region in the second frame; and
creating the intermediate frame by interpolating from the calculated vector fields and assigning an alternate vector in the identified occlusion region.

2. The method of claim 1 wherein the first and second frames are sequential.

3. The method of claim 1 wherein the method is performed as part of retiming the sequence.

4. The method of claim 1 wherein calculating the forward vector field comprises applying an optical flow algorithm.

5. The method of claim 1 wherein automatically identifying at least one occluded region comprises identifying asymmetries between the forward vector field and the reverse vector field.

6. The method of claim 1 wherein assigning the alternate vector comprises selecting a vector from the forward vector field that is in a background region.

7. The method of claim 1 wherein assigning the alternate vector comprises selecting a vector from the reverse vector field that is in a foreground region.

8. The method of claim 1, further comprising determining a blend weighting and adjusting the pixel blend of the alternate vector based on the determined weighting.

9. The method of claim 8 wherein determining the blend weighting comprises determining the divergence between the alternate vector and a vector from the calculated forward and reverse vector fields.

10. The method of claim 8 wherein determining the blend weighting comprises receiving a user-tunable weighting value.

11. A system for automatically identifying occluded regions based on the motion of an object depicted in a pair of video frames, the system comprising:
a receive frame component configured to receive the pair of video frames;
a calculate vector field component configured to calculate vector fields for warping each of the pair of video frames onto the other; and
an identify occluded region component configured to automatically identify an occluded region by detecting at least one asymmetry between the calculated vector fields.

12. The system of claim 11, further comprising a create intermediate frame component configured to create an intermediate frame positioned in time between the pair of video frames.

13. the system of claim 12 wherein the intermediate frame is halfway in time between the pair of video frames.

14. The system of claim 11 wherein the occluded region is created by a foreground object moving against a substantially stationary background.

15. The system of claim 11 wherein the received frames are part of a motion picture.

16. The system of claim 11, further comprising an output occlusion information component configured to provide information describing the determined occluded region to a motion blur component.

17. The system of claim 11, further comprising an output occlusion information component configured to provide information describing the determined occluded region to a retimer component.

18. A computer-readable medium containing instructions for controlling a computer system to produce an in-between image between a first existing image and a second existing image, by a method comprising:
receiving a first vector field that identifies the movement of pixels from the first existing image to the second existing image;
receiving a second vector field that identifies the movement of pixels from the second existing image to the first existing image;
identifying occluded regions by comparing the first and second vector fields;
creating an in-between image by interpolating the received vector fields to produce a warp vector field that identifies the movement of pixels from the in-between image to each of the existing images; and
for occluded regions, assigning a missing vector to the created in-between image by:
identifying a target location;
offsetting the target location by subtracting the vector at the target location in the first vector field to identify an offset location;
determining whether a warp vector exists for the offset location; and
if a warp vector exists at the offset location, assigning the warp vector at the offset location as the vector for the target location.

19. The computer-readable medium of claim 18, further comprising, if a warp vector does not exist at the offset location, assigning the vector at the target location in the first vector field as the vector for the target location.

20. The computer-readable medium of claim 18, further comprising, after assigning the vector for the target location, adjusting the weight of the vector for the target location.
